(19) United States
(12) Patent Application Publication
(10) Pub. No.: US 2001/0021193 A1
(43) Pub. Date: Sep. 13, 2001

(54) Device for and method of filtering signals

(76) Inventors: Bagher Aschrafi, Wendlingen (DE); Rainer Bader, Leinfelden (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/791,563

(22) Filed: Feb. 16, 2001

(30) Foreign Application Priority Data
Mar. 9, 2000 (DE) 100 11 125.4

(51) Int. Cl. H04L 12/28; H04L 12/56; H04L 12/66

(52) U.S. Cl. 370/419; 370/463

(57) ABSTRACT

For a communications system in which XDSL is combined with ISDN/POTS, the invention provides a device (3, 6) for filtering ISDN and POTS signals from composite signals containing an ISDN signal component and an ISDN DC component or a POTS signal component and a POTS DC component. The device (3, 6) is characterized in that it comprises a series combination of a first separating filter (9), a filter bank (10), and a second separating filter (11), that the separating filters (9, 11) are adapted to transfer the ISDN and POTS signal components via the filter bank (10) and to transfer the ISDN and POTS DC components via a separate path (13, 14), that a detector (12) is provided which is adapted to detect the ISDN and POTS DC components, that the filter bank (10) comprises an ISDN filter (15) and a POTS filter (16) which are controllable via the detector (12), that the detector (12) activates the ISDN filter (15) when the ISDN DC component was detected, and that the detector (12) activates the POTS filter (16) when the POTS DC component was detected.

This invention relates to a device for filtering signals as set forth in the preamble of claim 1, to a device for filtering signals as set forth in the preamble of claim 11, and to a method of filtering signals as set forth in the preamble of claim 8.

In many of today's communications networks, subscribers are connected using XDSL technologies. DSL means “digital subscriber line”, i.e., a subscriber is given digital access with a data rate in the megabit range. This is particularly advantageous for a connection to the Internet, since the downloading of information, which frequently includes video information, is accelerated. The letter X stands for A (asynchronous), S (synchronous), H (high bit rate), or V (very high bit rate), for example. An ADSL modem, for example, is installed at the subscriber end to provide access to various services. To integrate Internet services and voice and/or video services, ADSL lines are also used to transmit ISDN (integrated services digital network) services or POTS (plain old telephone service).

The ISDN serves to transmit digital telephone signals and/or digital video-telephone signals, for example. The POTS serves to transmit analog telephone signals.

A subscriber who has had only an analog telephone connection can upgrade his connection with ADSL so that he can continue to telephone via analog facilities but can surf in the Internet at the same time.

Thus, to transmit particularly speech over ADSL, ISDN or POTS is used. ISDN or POTS is transmitted in a first frequency range, and ADSL in a second frequency range. The two frequency ranges do not overlap. A facility is needed which separates ISDN and POTS signals. Generally, a POTS filter and an ISDN filter are used. Both in the case of ISDN and in the case of POTS, DC components are transmitted along with the user information signals for the purpose of remote power feeding. Because of the DC components, coils are required in the series arms of the filters. The coils are expensive, because they must meet exacting requirements.

The invention discloses a device for filtering signals as set forth in claim 1, a device for filtering signals as set forth in claim 11, and a method of filtering signals as set forth in claim 8.

The invention provides in particular a device for filtering ISDN and POTS signals from composite signals containing an ISDN signal component and an ISDN DC component or a POTS signal component and a POTS DC component which is characterized in that it comprises a series combination of a first separating filter, a filter bank, and a second separating filter, that the separating filters are adapted to transfer the ISDN and POTS signal components via the filter bank and to transfer the ISDN and POTS DC components via a separate path, that a detector is provided which is adapted to detect the ISDN and POTS DC components, that the filter bank comprises an ISDN filter and a POTS filter which are controllable via the detector, that the detector activates the ISDN filter when the ISDN DC component was detected, and that the detector activates the POTS filter when the POTS DC component was detected.

The DC component of the remote power supply is separated from the ISDN user information signals, for example by means of a capacitor, and forwarded over a separate path. Thus, the signals to be filtered no longer contain a DC component, i.e., a DC offset. This makes it possible to use filters of a simpler design, for example capacitors in place of coils in the series arms of the filters, or filters with a lower dielectric strength, for example in the range of 10 to 15 volts instead of 100 volts. Capacitors have smaller dimensions than coils, are less expensive, and are easier to incorporate into the circuit. Capacitors are also suitable for integration, which reduces the costs of the filters. The filters can also be constructed from active components using thyristors, for example. In addition, the value of the DC component of a received composite signal is detected, or it is at least determined whether the value of the DC component lies above or below a predetermined threshold. ISDN signals are transmitted together with a remote power supply voltage of approximately 100 volts, for example, while POTS signals are transmitted together with a remote power supply voltage of approximately 60 volts. Using a threshold at about 80 volts, ISDN and POTS signals are distinguishable; if the remote power supply voltage is above 80 volts, the signals are ISDN signals, and if it is below 80 volts, the signals are POTS signals. Depending on the value of the DC component, either the ISDN filter or the POTS filter will be automatically turned on, i.e., activated. The detector thus determines in a simple manner whether ISDN or POTS signals are being received, and turns the associated filter on. The received signals are applied to the respective filter. The filter selects the appropriate signal from the applied composite signal, which may additionally contain ADSL signals, and transfers only this signal. When no ISDN signal is present any more, the associated filter will be turned off, i.e., deactivated. In the off or deactivated state, the filter consumes no power. Accordingly, power is saved when no signals are being received or are present. No separate power supply is required for the filters. The remote power supply can be used to power the filters. To accomplish this, the detector comprises a DC/DC converter which converts the applied remote power supply voltage, e.g., 100 volts in the case of ISDN, to a voltage suitable for the filters, e.g., 5 volts.

Thus, low-cost integration of ADSL (or SDSL or XDSL) and ISDN or POTS is made possible in a simple manner.

The invention also provides a method of filtering first and second signals from composite signals containing a first signal component and a first DC component or a second signal component and a second DC component which is characterized in that the signal component and the DC component of a received composite signal are separated from one another, that depending on the magnitude of the DC component, a given filter is activated, to which the signal component is applied, and that the filtered signal component and the DC component are subsequently combined.

Thus, the invention is not limited to the integration of ADSL and ISDN or POTS but can be applied in particular to all systems in which at least two different information signals which are each transmitted with DC components must be separated from one another.

The invention will become more apparent from the following description taken in conjunction with the accompanying five figures, in which:

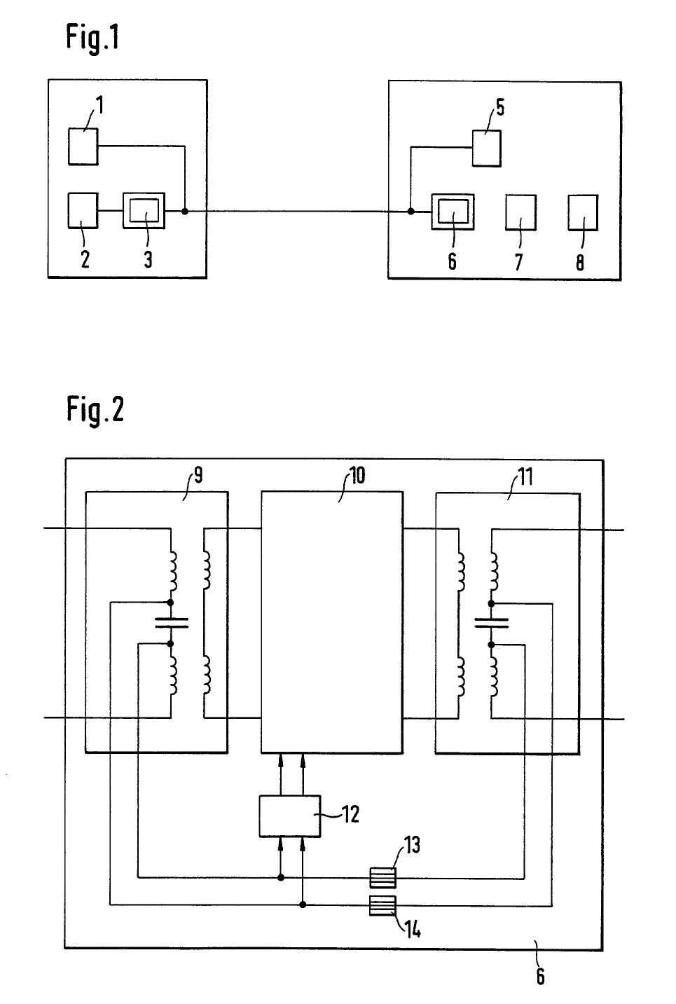

FIG. 1 is a schematic block diagram of a part of communications network for transmitting ADSL and ISDN/POTS;

FIG. 2 is a schematic diagram of a device according to the invention for filtering ISDN and POTS;

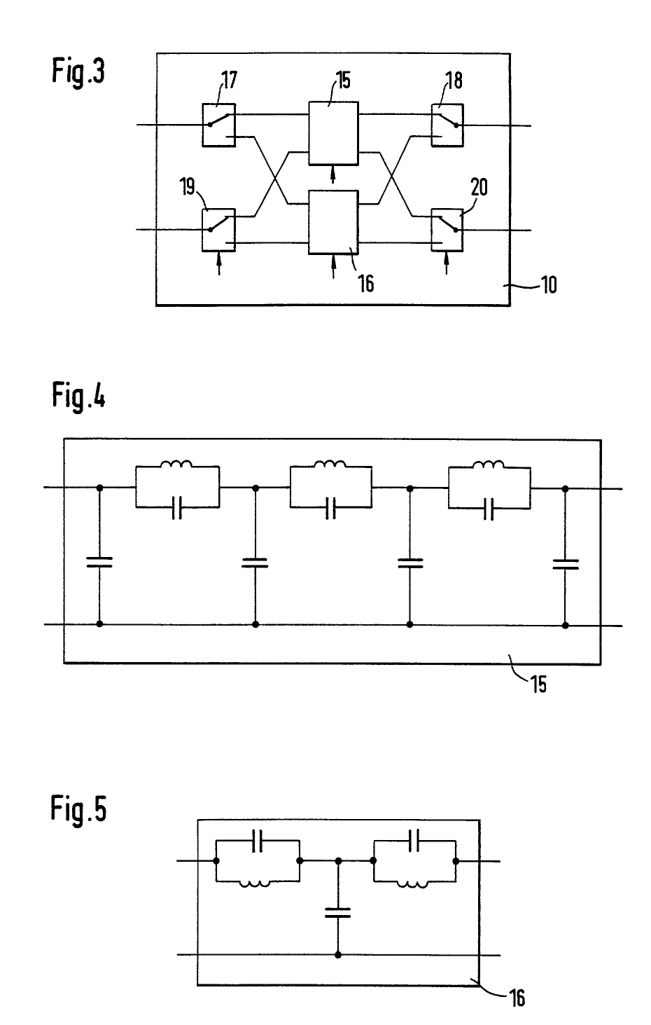

FIG. 3 is a schematic block diagram of the filter bank of the device of FIG. 2;

FIG. 4 is a schematic diagram of the ISDN filter of the filter bank of FIG. 3;

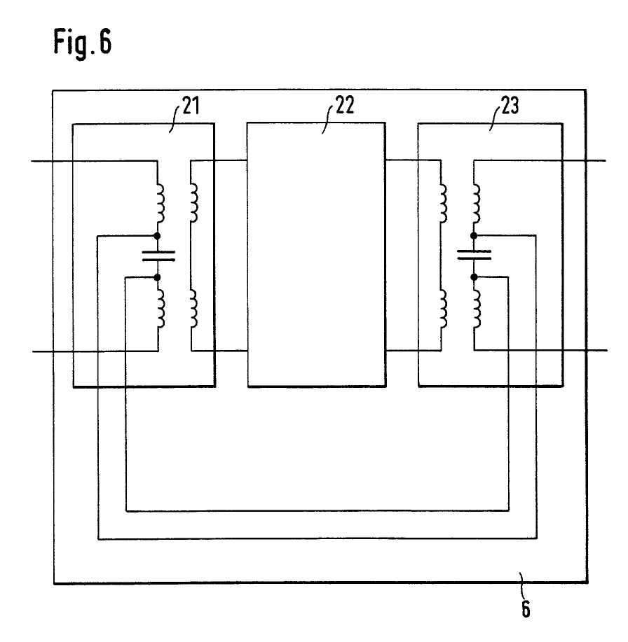

FIG. 5 is a schematic diagram of the POTS filter of he filter bank of FIG. 3; and

FIG. 6 is a schematic diagram of a device according to the invention for filtering signals.

The first embodiment will first be explained with reference to FIG. 1. FIG. 1 shows a portion of a communications network for transmitting ADSL and ISDN/POTS. The communications network is a conventional telephone network, in which there are point-to-point links from an exchange to individual subscribers. The subscribers may be both ISDN and POTS customers. The communications network thus supports both the old, analog lines and digital ISDN lines. In addition, the communications network is ADSL-capable. Each ADSL customer has an ADSL modem 5, via which ADSL traffic, such as Internet access, is handled. Thus, over a line 4 between the exchange and a subscriber, two services are provided simultaneously: ADSL and ISDN or ADSL and POTS. A device 3 at the exchange end and a device 6 at the subscriber end filter the ISDN or POTS signals. In the example shown, the subscriber is an ADSL and ISDN customer. He has an ADSL modem 5 for the ADSL services, and he has a device 6 for filtering the ISDN signals from the composite signal received from the exchange, which contains ADSL signals, ISDN signals, and ISDN DC components. The output signals of the device 6 at the subscriber end contain only ISDN signals, including the ISDN DC components, i.e., the ADSL signals have been removed.

Device 6 thus represents a network termination with integrated filter function which is particularly suitable for use in networks in which aside from ISDN signals, additional services, such as XDSL, are offered which are commonly transmitted in another frequency range, so that the ISDN signals can be separated by means of a filter. Device 6 can also be used in cable television distribution networks that are upgraded with an upstream channel, so that aside from the distribution of television signals, communications services, such as ISDN, can be offered as an overlay. Use of device 6 is also possible in power line networks, in which the ISDN signals must be separated at the subscriber end. The ISDN signals and the DC component are applied to an ISDN network termination 7. Network termination 7 is usually a so-called NTBA with two bearer channels (two 64-kb/s B channels) and one signaling channel (one 16-kb/s D channel); NTBA=Network Termination Basic rate Access. Up to eight terminals 8, e.g., an ISDN telephone, a fax machine, a video telephone, etc., can be connected to network termination 7. The ADSL information transmitted from a subscriber to the exchange, such as request signals, is transferred through an ADSL module 1 into a network independent of the telephone network, e.g., to an Internet service provider. The ISDN information transmitted from a subscriber to the exchange, e.g., telephone signals, is transferred through device 3, which removes all ADSL signals and passes the ISDN signals, to an ISDN module 2 and from there into the ISDN network. Instead of the combination of ADSL and ISDN, a combination of ADSL and POTS can be used. Then, module 2 will be a POTS module and network termination 7 will be a POTS network termination with integrated filter function. Terminals 8 will be POTS terminals, such as analog telephones.

The first embodiment will now be further explained with reference to FIG. 2. FIG. 2 shows a device according to the invention for filtering ISDN and POTS. The device corresponds to device 6 of FIG. 1. Devices 3 and 6 of FIG. 1 are identical in construction and are both suitable for bidirectional filtering, so that a detailed description of device 3 can be dispensed with. Devices 3 and 6 can be used both for the combination of ADSL and ISDN and for the combination of ADSL and POTS, i.e., they are universally applicable.

Device 6 comprises a series combination of a first separating filter 9, a filter bank 10, and a second separating filter 11. It further includes a detector 12 and two chokes 13 and 14.

During the use of an ISDN connection between exchange and subscriber, ISDN signal components (user information) and DC components (for remote power feeding purposes) are transmitted from the exchange to the subscriber. Both the ISDN signal components and the ISDN DC components are received by separating filter 9. Separating filter 9 contains a repeating coil whose primary side is formed by a series combination of a first coil, a capacitor, and a second coil, with the DC component being picked off between the capacitor and the first coil and between the capacitor and the second coil. The secondary side contains a series combination of a third coil and a fourth coil. The repeating coil provides electric isolation, whereby interferences are minimized. The ISDN signal component is transferred from the primary side to the secondary side and fed to filter bank 10. The ISDN DC component is picked off on the primary side and transferred over separate lines to separating filter 11, i.e., it is not transferred through filter bank 10 in particular. Two chokes are inserted in the separate lines. They have a passband up to 50 hertz and are designed as electronic chokes. They serve as low-pass filters to block the ISDN signal components and the ADSL signals.

Detector 12 is designed as a threshold detector. It has a threshold at about 80 volts. The function of detector 12 is to determine whether the received DC component is above or below the threshold. In ISDN, power is provided at approx. 100 volts, while in POTS, approx. 60 volts are supplied. When a DC voltage component above the threshold is determined, the signals are ISDN signals. When a DC voltage component below the threshold is determined, the signals are POTS signals.

Filter bank 10 comprises two filters, namely an ISDN filter for filtering the ISDN signal components and a POTS filter for filtering the POTS signal components. Both filters are controlled by detector 12. When detector 12 detects ISDN signal components, the ISDN filter will be activated; when the detector detects POTS components, the POTS filter will be activated. The activation is effected by reversal of switches. The switches may also be designed as relays which activate the POTS filter in one position and the ISDN filter in the other.

Detector 12 additionally includes a DC/DC converter for deriving the supply voltage for the active filter from the remote power supply voltage. A portion of the ISDN DC component is converted from, e.g., 100 volts to 5 volts and fed to the ISDN filter. In the POTS mode, a portion of the POTS DC component is converted to a different DC voltage value, which is fed to the POTS filter.

The ISDN or POTS signal components filtered in filter bank 10 are fed to separating filter 11. Separating filter 11 contains a repeating coil. The primary side of the repeating coil contains a series combination of a first coil, a capacitor, and a second coil, the DC component being injected between the capacitor and the first coil and between the capacitor and the second coil. The secondary side contains a third coil and a fourth coil in series. The repeating coil serves to provide electric isolation, whereby interferences are minimized. The filtered ISDN or POTS signal component is transferred from the secondary side to the primary side and passed, together with the associated DC component, to the output.

The first embodiment will now be further explained with the aid of FIG. 3. FIG. 3 shows a schematic block diagram of the novel filter bank 10 of FIG. 2. Filter bank 10 contains an ISDN filter 15, a POTS filter 16, and four switches 17, 18, 19, 20. The four switches 17, 18, 19, 20 are arranged to activate the ISDN filter in one position and the POTS filter in the other. They are controlled by detector 12. Detector 12 additionally provides the supply voltages for filters 15 and 16. To save power, only the respective active filter is supplied with power.

The first embodiment will now be further explained with the aid of FIG. 4. FIG. 4 shows a schematic diagram of the ISDN filter 15 of FIG. 3. ISDN filter 15 has three series-connected LC sections in the series arm. Each LC section consists of a coil and a capacitor in parallel. Four shunt arms are provided, each of which contains a capacitor. The values of the capacitors and coils are chosen so that these devices can implement the filtering property in the frequency range assigned for the transmission of ISDN signals in an optimized manner. The ISDN filter may also be designed as a dual or equivalent of the above configuration.

The first embodiment will now be further explained with the aid of FIG. 5. FIG. 5 shows a schematic diagram of the POTS filter 16 of FIG. 3. POTS filter 16 has two series-connected LC sections in the series arm. Each LC section consists of a coil and a capacitor in parallel. One shunt arm is provided, which contains a capacitor. The values of the capacitors and coils are chosen so that these devices can implement the filtering property in the frequency range assigned for the transmission of POTS signals in an optimized manner. The POTS filter may also be implemented as a dual or equivalent of the above configuration.

The first embodiment shows an application of the invention to ISDN and POTS. However, the invention is not limited to these signals. The invention can also be used with more than two signals. The filter bank will then contain more than two activatable filters. In principle, all composite signals containing at least two signal components and at least one DC component can be detected and filtered.

The second embodiment will now be explained with the aid of FIG. 6. FIG. 6 shows another device according to the invention for filtering signals. The device corresponds to device 6 of FIG. 1, for example. Devices 3 and 6 of FIG. 1 are identical in construction, so that a detailed description of device 3 can be dispensed with. Devices 3 and 6 are used both for the combination of ADSL and ISDN and for the combination of ADSL and POTS, i.e., they are universally applicable.

The device of FIG. 6 serves to filter signals from composite signals containing a first signal component and a first DC component. The device contains a series combination of a first separating filter 21, a filter 22, and a second separating filter 23. Separating filters 21 and 23 are identical in construction and operation to separating filters 9 and 11 of FIG. 2. Separating filters 21, 23 are designed or transfer the first signal component, e.g., an ISDN signal component or a POTS signal component, via filter 22 and to transfer the first DC component, e.g., an ISDN DC component or a POTS DC component, via a separate path. Filter 22 is designed as an ISDN filter or as a POTS filter, for example. Unlike the device of FIG. 2, the device of FIG. 6 includes only a filter that is hard-wired and cannot be activated and deactivated, but is constantly on. Filter 22 is identical in construction to either of the filter of FIGS. 4 and 5. Filter 22 may be designed as a passive filter, in which case it required no power supply.

The composite signal may contain at least a second signal component, particularly an XDSL signal component. Separating filters 21, 23 are designed to transfer the second signal component to filter 22. Filter 22 is designed to block the second signal component and pass the first signal component.

In contrast to FIG. 2, the detector is not necessary, which simplifies the circuit configuration. Without the detector, different signal components are not distinguished one from the other, so that depending on the filter 22 used, the device of FIG. 6 can, as a rule, filter only one given signal component. If different signal components are transmitted in different frequency ranges, such as POTS and ISDN below a given threshold, for example 20 kHz for POTS or 100 kHz for ISDN, and ADSL above this threshold, more than one signal component can be filtered using a low-pass filter. A low-pass filter with a suitably chosen cutoff frequency, e.g., 100 kHz, can thus be used to filter ISDN and POTS signals; ADSL signals are then blocked.

Filter 22 can also be designed as a plug-in module. The device is then easily adaptable to different signal components. For example, the housing, the two separating filters 21, 23, and the slot for filter 22 are prefabricated. Depending on the situation for which the device is to be used, for example for ISDN filtering, the appropriate filter type will then be simply inserted at the intended location. The plug-in variant is also advantageous during repair work, conversion work, maintenance work, etc.

1. A device (3, 6) for filtering ISDN and POTS signals from composite signals containing an ISDN signal component and an ISDN DC component or a POTS signal component and a POTS DC component, characterized in that the device comprises a series combination of a first separating filter (9), a filter bank (10), and a second separating filter (11), that the separating filters (9, 11) are adapted to transfer the ISDN and POTS signal components via the filter bank (10) and to transfer the ISDN and POTS DC components via a separate path (13, 14), that a detector (12) is provided which is adapted to detect the ISDN and POTS DC components, that the filter bank (10) comprises an ISDN filter (15) and a POTS filter (16) which are controllable via the detector (12), that the detector (12) activates the ISDN filter (15) when the ISDN DC component was detected, and that the detector (12) activates the POTS filter (16) when the POTS DC component was detected.

2. A device (3, 6) as claimed in claim 1, characterized in that each of the separating filters (9, 11) comprises a repeating coil having a primary side and a secondary side, that the primary side contains a series combination of a first coil, a capacitor, and a second coil, the DC component being picked off between the capacitor and the first coil and between the capacitor and the second coil, and that the secondary side contains a series combination of a third coil and a fourth coil.

3. A device (3, 6) as claimed in claim 1, characterized in that the detector (12) is a threshold detector which activates the ISDN filter (15) upon detection of a DC component above a predetermined threshold, particularly above a threshold lying between 60 volts and 100 volts, and which activates the POTS filter (16) upon detection of a DC component below the threshold.

4. A device (3, 6) as claimed in claim 1, characterized in that the filter bank (10) further comprises at least two switches (17, 18, 19, 20) controlled by the detector (12) for activating and deactivating the ISDN filter (15) and the POTS filter (16).

5. A device (3, 6) as claimed in claim 1, characterized in that the detector (12) comprises a DC/DC converter for deriving the direct current required by the filter (15, 16) to be activated from the detected DC component.

6. A device (3, 6) as claimed in claim 1, characterized in that each of the filters (15, 16) consists of a series arm and at least one shunt arm, the series arm containing a series combination of at least two LC sections, and the at least one shunt arm containing a capacitor.

7. A device (3, 6) as claimed in claim 1, characterized in that each of the separating filters (9, 11) comprises an optocoupler for providing electric isolation.

8. A method of filtering first and second signals from composite signals containing a first signal component and a first DC component or a second signal component and a second DC component, characterized in that the signal component and the DC component of a received composite signal are separated from one another, that depending on the magnitude of the DC component, a given filter (15, 16) is activated, to which the signal component is applied, and that the filtered signal component and the DC component are subsequently combined.

9. A method as claimed in claim 8, characterized in that the first signal component is an ISDN signal component, the first DC component is an ISDN DC component, the second signal component is a POTS signal component, and the second DC component is a POTS DC component.

10. A method as claimed in claim 8, characterized in that the first signal component is a digital telephone signal component, the first DC component is an associated DC component, the second signal component is an analog telephone signal component, and the second DC component is an associated DC component.

11. A device (3, 6) for filtering signals from composite signals containing a first signal component and a first DC component, characterized in that the device comprises a series combination of a first separating filter (21), a filter (22), and a second separating filter (23), and that the separating filters (21, 23) are adapted to transfer the first signal component via the filter (22) and to transfer the first DC component via a separate path.

12. A device (3, 6) as claimed in claim 11, characterized in that the filter (22) is an ISDN filter or a POTS filter.

13. A device (3, 6) as claimed in claim 11, characterized in that the composite signal comprises a second signal component, particularly an XDSL signal component, that the separating filters (21, 23) are adapted to transfer the second signal component to the filter (22), and that the filter (22), is adapted to block the second signal component and to pass the first signal component.
